(19) United States
(12) Patent Application Publication
(10) Pub. No.: US 2016/0274362 A1
(43) Pub. Date: Sep. 22, 2016

(54) LIGHT COMBINER FOR AUGMENTED REALITY DISPLAY SYSTEMS

(71) Applicant: Magic Leap, Inc., Dania Beach, FL (US)

(72) Inventor: David Alan Tinch, Fort Lauderdale, FL (US)

(21) Appl. No.: 15/072,055

(22) Filed: Mar. 16, 2016

Related U.S. Application Data
(60) Provisional application No. 62/136,393, filed on Mar. 20, 2015.

(51) Int. Cl. G02B 27/01; G02B 6/293; G02B 27/10

(52) U.S. Cl. CPC G02B 27/0172; G02B 27/102; G02B 6/29332; G02B 2027/0112

(57) ABSTRACT

A planar light combiner includes a planar substrate having a planar waveguide therein. The planar waveguide includes a first channel and a second channel. The first channel is configured to propagate at least a first light having a first wavelength. The second channel is configured to propagate at least a second light having a second wavelength. The first channel intersects the second channel such that the first light is combined with the second light.

### CROSS-REFERENCE TO RELATED APPLICATION

This application claims priority to U.S. Provisional Application Ser. No. 62/136,393 filed on Mar. 20, 2015 entitled “HYPER INTEGRATED VISIBLE WAVELENGTH COMBINER FOR AUGMENTED REALITY DISPLAY SYSTEMS,” under attorney docket number ML.30057.00. The content of the aforementioned patent application is hereby expressly incorporated by reference in its entirety for all purposes as though set forth in full.

### FIELD OF THE INVENTION

The present disclosure relates to systems and methods for combining light having different wavelengths and from discrete inputs into a single output channel.

### BACKGROUND

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user.

For example, referring to FIG. 1, an augmented reality scene 4 is depicted wherein a user of an AR technology sees a real-world park-like setting 6 featuring people, trees, buildings in the background, and a concrete platform 1120. In addition to these items, the user of the AR technology also perceives that he “sees” a robot statue 1110 standing upon the real-world platform 1120, and a cartoon-like avatar character 2 flying by which seems to be a personification of a bumble bee, even though these elements 2, 1110 do not exist in the real world. As it turns out, the human visual perception system is very complex, and producing a VR or AR technology that facilitates a comfortable, natural-feeling, rich presentation of virtual image elements amongst other virtual or real-world imagery elements is challenging.

In some embodiments, in order to display a scene similar to that shown in FIG. 1, a fiber scanning display (“FSD”) may be used to feed a set of light rays into a set of optics that deliver light to a user's eyes. The fiber scanning display scans a narrow beam of light back and forth at an angle to project an image through a lens or other optical elements. The optical elements may collect the angularly-scanned light and focus it accordingly based on the image to be displayed and the accommodation of the user.

An important aspect of presenting a realistic augmented reality experience is to ensure the display of realistic colored images. With a system using a fiber scanned display, this may be achieved through the use of red/green/blue (“RGB”) lasers, which may be combined into a single output. For visible wavelengths, the most common type is an RGB combiner. As used in this application, “visible wavelengths,” include wavelengths from about 400 nm to about 700 nm. These wavelengths can be used to generate entire color palates for display technologies. It should be appreciated that each of the RGB lasers is associated with its own particular wavelength and combining the three or more discrete lasers into one may pose many challenges.

When designing a light combiner, both the size and the weight of the light combiner must be considered. These facts are especially important in context of head-worn augmented reality display systems. A small size combiner facilitates device designs that are aesthetically appealing to consumers. Similarly, a light weight combiner is also desirable because AR display devices may be configured to be worn directly on the user's head, thereby the weight of the device directly affects comfort and appeal for the user of the head-worn AR display device.

There, thus, is a need for a better solution to combining lasers of multiple wavelengths into a single light beam to be delivered to an output channel, while maintaining the size and weight of the AR device at acceptable levels.

### SUMMARY

Embodiments of the present invention are directed to devices, systems and methods for combining light having different wavelengths into a single light beam to facilitate virtual reality and/or augmented reality displays for one or more users. As discussed above, light combiners configured to combine visible light may be too big and heavy for use in head worn AR display devices. The embodiments described herein address the size and weight limitations of visible light combiners using planar waveguides and optical elements associated therewith.

In one embodiment, a planar light combiner includes a planar substrate having a planar waveguide therein. The planar waveguide includes a first channel and a second channel. The first channel is configured to propagate at least a first light having a first wavelength. The second channel is configured to propagate at least a second light having a second wavelength. The first channel intersects the second channel such that the first light is combined with the second light.

In one or more embodiments, each of the first and second wavelengths is in a range of about 400 nm to about 700 nm. The second channel may be configured to propagate the first light having the first wavelength.

In one or more embodiments, the planar substrate includes an input side and an output side. The second channel may span the planar substrate between the input side and the output side. The first and second channels may include respective first and second inputs at the input side. The second channel may also include an output channel at the output side. The output channel may be a single mode channel. The first channel may not extend to the output side.

In one or more embodiments, the planar light combiner is monolithic. The planar waveguide in the planar substrate may have at least one waveguide refractive index that is higher than a non-waveguide refractive index in a non-waveguide portion of the planar substrate. The first light may be combined with the second light by evanescent coupling. The first light may be combined with the second light to form a multiplexed wavelength light. The first and second channels may be single mode channels.

In one or more embodiments, the planar waveguide also includes a third channel. The third channel is configured to propagate at least a third light having a third wavelength. The third channel intersects the second channel such that the third light is combined with the second light.

In another embodiment, a light generator includes a planar light combiner, and first and second light sources. The planar light combiner includes a planar substrate having a planar waveguide therein. The planar waveguide includes a first channel and a second channel. The first channel is configured to propagate at least a first light having a first wavelength. The second channel is configured to propagate at least a second light having a second wavelength. The first channel intersects the second channel such that the first light is combined with the second light. The first light source is configured to deliver the first light to the first channel of the planar waveguide. The second light source is configured to deliver the second light to the second channel of the planar waveguide.

In one or more embodiments, the first and second light sources are lasers. The light generator may also include a first lens disposed between the first light source and the first channel, and a second lens disposed between the second light source and the second channel. The first light source, the first lens, and the first channel may be aligned such that the first light from the first light source is delivered to the first channel. The second light source, the second lens, and the second channel may be aligned such that the second light from the second light source is delivered to the second channel. The first lens may be configured to improve a coupling efficiency between the first light source and the first channel by modifying one or more characteristics of the first light. The second lens may be configured to improve a coupling efficiency between the second light source and the second channel by modifying one or more characteristics of the second light. The one or more characteristics may be one or more of mode field diameter and numerical aperture.

In one or more embodiments, the light generator also includes an optical fiber configured to receive a multiplexed wavelength light from the second channel of the planar waveguide. The optical fiber may be a single mode fiber. The optical fiber may be directly coupled to the planar substrate adjacent the second channel. The light generator may further include a lens disposed between the second channel and the optical fiber. The lens may be configured to improve a coupling efficiency between the optical fiber and the second channel by modifying one or more characteristics of the multiplexed wavelength light. The one or more characteristics may be one or more of mode field diameter and numerical aperture. The second channel and the optical fiber may have substantially the same mode field diameter and numerical aperture.

In one or more embodiments, the planar waveguide also includes a third channel, and the light generator also includes a third light source configured to deliver a third light having a third wavelength to the third channel of the planar waveguide. The third channel may be configured to propagate at least the third light. The third channel may intersect the second channel such that the third light is combined with the second light. The light generator may also include a third lens disposed between the third light source and the third channel. The third light source, the third lens, and the third channel may be aligned such that the third light from the third light source is delivered to the third channel.

Additional and other objects, features, and advantages of the invention are described in the detail description, figures and claims.

### BRIEF DESCRIPTION OF THE DRAWINGS

The drawings illustrate the design and utility of various embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a plan view of an AR scene displayed to a user of an AR system according to one embodiment.

FIGS. 2A-2D are schematic views of wearable AR devices according to various embodiments.

FIG. 3 is a schematic view of a wearable AR device according to one embodiment interacting with one or more cloud servers of an AR system while being worn by a user.

FIG. 4 is a schematic view of a light generator including a light combiner according to one embodiment.

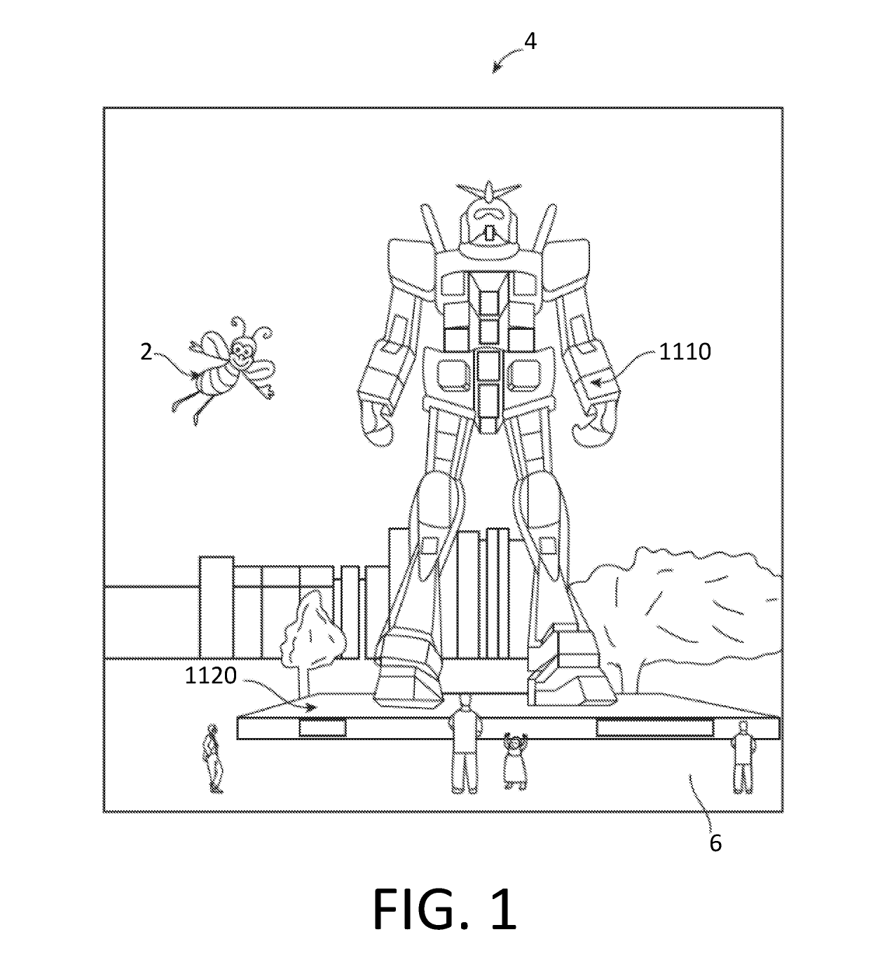

### DETAILED DESCRIPTION

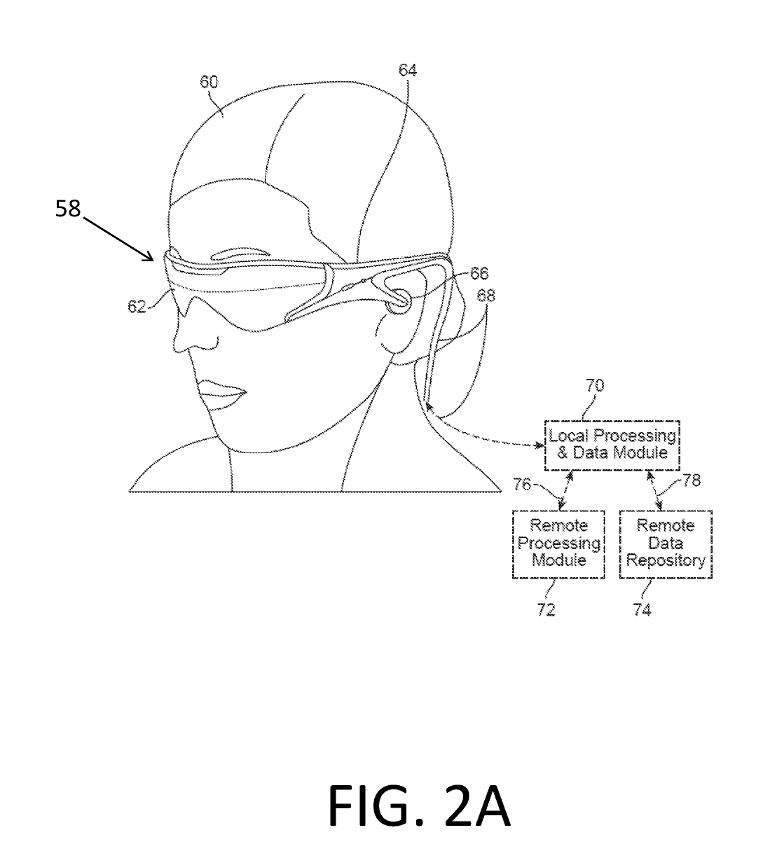

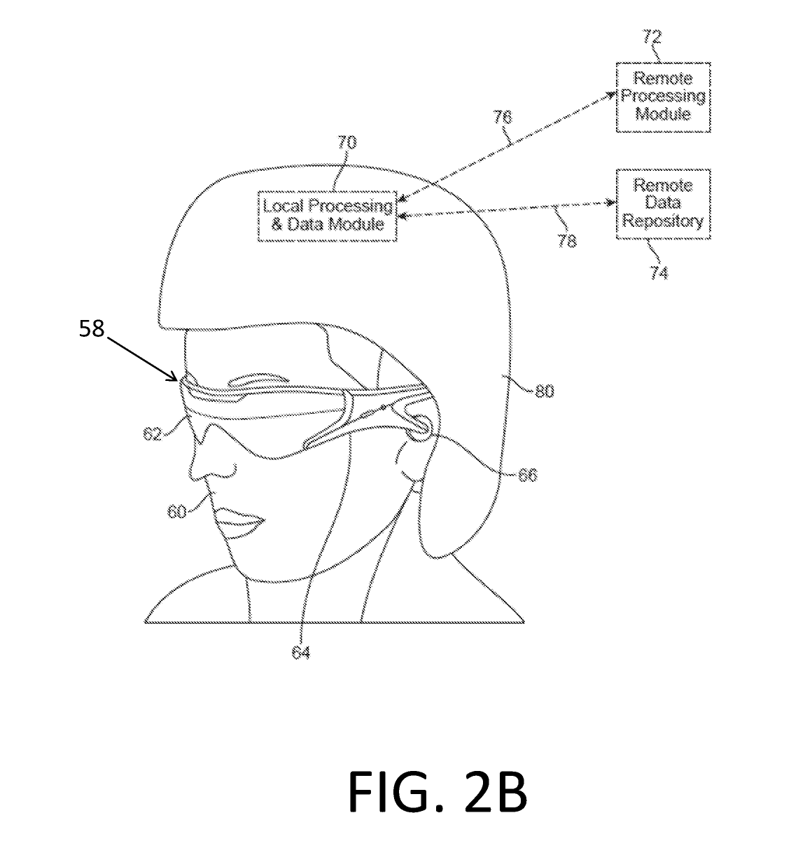

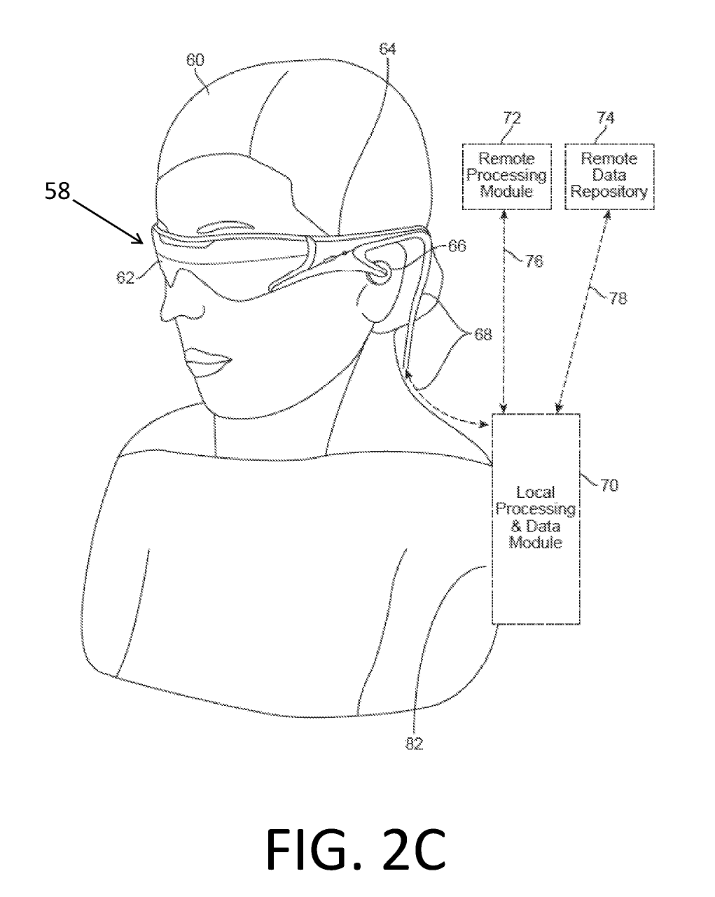

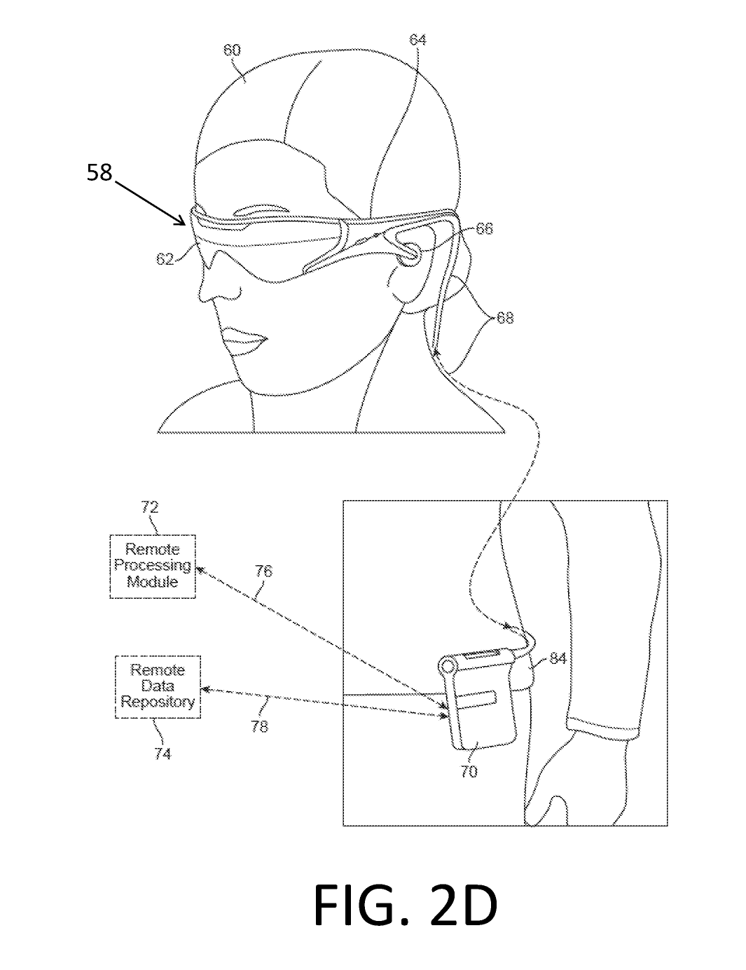

Referring to FIGS. 2A-2D, some general componentry options are illustrated. In the portions of the detailed description which follow the discussion of FIGS. 2A-2D, various systems, subsystems, and components are presented for addressing the objectives of providing a high-quality, comfortably-perceived display system for human VR and/or AR.

As shown in FIG. 2A, an AR system user 60 is depicted wearing a head mounted component 58 featuring a frame 64 structure coupled to a display system 62 positioned in front of the eyes of the user. A speaker 66 is coupled to the frame 64 in the depicted configuration and positioned adjacent the ear canal of the user (in one embodiment, another speaker, not shown, is positioned adjacent the other ear canal of the user to provide for stereo/shapeable sound control). The display 62 may be operatively coupled 68, such as by a wired lead or wireless connectivity, to a local processing and data module 70 which may be mounted in a variety of configurations, such as fixedly attached to the frame 64, fixedly attached to a helmet or hat 80 as shown in the embodiment of FIG. 2B, embedded in headphones, removably attached to the torso 82 of the user 60 in a backpack-style configuration as shown in the embodiment of FIG. 2C, or removably attached to the hip 84 of the user 60 in a belt-coupling style configuration as shown in the embodiment of FIG. 2D.

The local processing and data module 70 may comprise a power-efficient processor or controller, as well as digital memory, such as flash memory, both of which may be utilized to assist in the processing, caching, and storage of data (a) captured from sensors which may be operatively coupled to the frame 64, such as image capture devices (such as cameras), microphones, inertial measurement units, accelerometers, compasses, GPS units, radio devices, and/or gyros; and/or (b) acquired and/or processed using the remote processing module 72 and/or remote data repository 74, possibly for passage to the display 62 after such processing or retrieval. The local processing and data module 70 may be operatively coupled 76, 78, such as via a wired or wireless communication links, to the remote processing module 72 and remote data repository 74 such that these remote modules 72, 74 are operatively coupled to each other and available as resources to the local processing and data module 70.

In one embodiment, the remote processing module 72 may comprise one or more relatively powerful processors or controllers configured to analyze and process data and/or image information. In one embodiment, the remote data repository 74 may comprise a relatively large-scale digital data storage facility, which may be available through the internet or other networking configuration in a “cloud” resource configuration. In one embodiment, all data may be stored and all computation may be performed in the local processing and data module, allowing fully autonomous use from any remote modules.

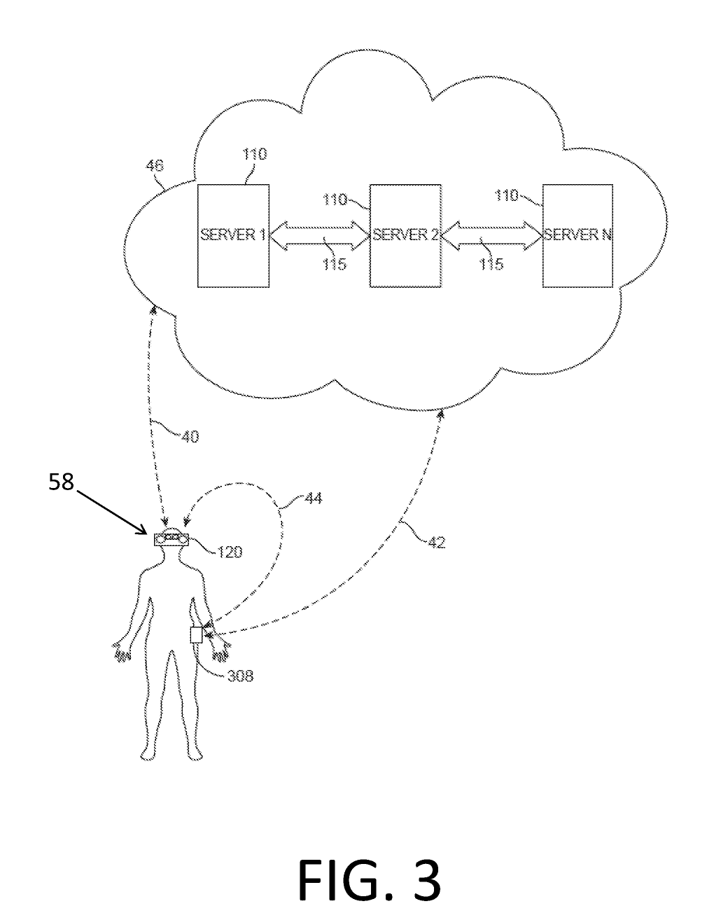

As described with reference to FIGS. 2A-2D, the AR system continually receives input from various devices that collect data about the AR user and the surrounding environment. Referring now to FIG. 3, the various components of an example augmented reality display device will be described. It should be appreciated that other embodiments may have additional components. Nevertheless, FIG. 3 provides an example of the various components of, and the types of data that may be collected by an AR system. FIG. 3 shows a simplified version of the head-mounted ophthalmic device 62 in the block diagram to the right for illustrative purposes.

Referring now to FIG. 3, a schematic illustrates coordination between the cloud computing assets 46 and local processing assets, which may, for example reside in a head mounted component 58 coupled to the user's head 120 and a local processing and data module 70, coupled to the user's belt 308 (therefore the component 70 may also be termed a “belt pack” 70), as shown in FIG. 3. In one embodiment, the cloud 46 assets, such as one or more server systems 110, are operatively coupled 115, such as via wired or wireless networking (wireless being preferred for mobility, wired being preferred for certain high-bandwidth or high-data-volume transfers that may be desired), directly to 40, 42 one or both of the local computing assets, such as processor and memory configurations coupled to a user's head 120 and belt 308, as described above. These computing assets local to the user may be operatively coupled to each other as well, via wired and/or wireless connectivity configurations 44. In one embodiment, to maintain a low-inertia and small-size subsystem mounted to the user's head 120, primary transfer between the user and the cloud 46 may be via the link between the subsystem mounted at the belt 308 and the cloud, with the head 12 mounted subsystem primarily data-tethered to the belt 308 based subsystem using wireless connectivity, such as ultra-wideband (“UWB”) connectivity, as is currently employed, for example, in personal computing peripheral connectivity applications.

With efficient local and remote processing coordination, and an appropriate display device for a user, such as the user interface or user display system 62 shown in FIG. 2A, or variations thereof, aspects of one world pertinent to a user's current actual or virtual location may be transferred or “passed” to the user and updated in an efficient fashion. In other words, a map of the world may be continually updated at a storage location which may partially reside on the user's AR system and partially reside in the cloud resources. The map (also referred to as a “passable world model”) may be a large database comprising raster imagery, 3-D and 2-D points, parametric information and other information about the real world. As more and more AR users continually capture information about their real environment (e.g., through cameras, sensors, IMUs, etc.), the map becomes more and more accurate and complete.

More relevant to the current inventions, when projecting light to be displayed to the user, multi-mode or single-mode laser fibers may be used. Red/green/blue (“RGB”) lasers may be used to generate visible light. Such RGB lasers may be combined into a single output using an RGB combiner. Such combiners have been traditionally used in a wide range of technology areas such as telecommunication and data communication applications, medical devices, sensors, projection systems, consumer electronics, etc.

One approach to implementing an RGB combiner involves the use of step index planar waveguide technology. Existing planar waveguide devices may be designed for either single-mode or multi-mode light. There are differences between planar waveguide devices designed for single-mode and multi-mode light. In the case of single-mode light propagation, the waveguides must be correctly sized based on the wavelength of operation to maintain a single-mode propagation over long distances (i.e., for use in long haul telecommunications). Single-mode waveguides may also be more difficult to fabricate due to their small feature size. Generally, single-mode waveguides may require specialized manufacturing equipment.

As discussed at some length above, two main considerations when considering whether to incorporate RGB combiners in wearable AR display technologies are size and weight. Legacy approaches in combiner technologies have generally resulted in RGB combiners that are too big and/or too heavy to be comfortably incorporated into wearable display devices. Several approaches will be briefly outlined here. The main commonality between these technologies is that they are all relatively large in size.

One technique of manufacturing an RGB combiner uses individual optical fibers that may be drawn together into a single output fiber. Combiners manufactured using this technique may be 40 mm to 100 mm in length, and 9 mm² to 25 mm² in cross-sectional area. Because these combiners are fiber based, they typically require additional lengths of fiber that must be maintained in a linear shape to prevent breakage or high light loss that degrades light source function to an unacceptable level for AR applications. When using such a combiner in a device (e.g., an AR display device), a space of at least 4-6 inches may be required. However, when designing a compact AR display device, a space of 4-6 inches devoted solely to the RGB combiner adds to the overall size of the AR device, and may result in a sub-optimal AR device size.

In another approach, lasers packaged in transistor outline (“TO”) cans are used in a free space approach in combination with special filters. This combination of components with associated mechanics is assembled to focus each free space beam onto a single output fiber. A typical TO cans measures at least about 4 mm in diameter. However, this minimum TO can size, combined with even the minimum sizes of lenses, filters and mechanical parts, results in relatively large RGB combiner configuration sizes that may not be ideal for wearable devices such as the AR display device.

According to one embodiment, a hyper integrated approach based on embedded planar waveguide technology may be used to combine lasers having different wavelengths (e.g., from about 400 nm to about 700 nm) while minimizing AR device size. This approach minimizes both size and weight, and may be used to manufacture a compact combiner. The embedded planar waveguides may be similar in performance when compared to optical fibers but are fabricated on a flat substrate. Advantageously, the flat substrate on which the waveguides are fabricated is more durable then fiber-based combiners. The layout of the waveguide substrate may be designed such that three discrete inputs may be combined into a single output. It should be appreciated that the three discrete inputs may be any compatible light source, including laser diodes, LED's and/or optical fibers. The embodiments described herein include laser diodes, but it should be appreciated that any compatible light source(s) may be used in a similar fashion. The single output of the device may be coupled into a single-mode optical fiber such that the combined RGB light can be guided to a point of use.

The planar waveguide substrates according to various embodiments may be fabricated in sizes in the millimeter range. For example, in one embodiment, the dimensions of the planar waveguide substrate may be 5 mm×8 mm×1 mm. In other embodiments, the planar waveguide substrate may be larger or even smaller. In one or more embodiments, the planar waveguide substrate may be used in associated with additional lenses, lasers and/or optical elements, which may add a few more millimeters to the overall size of the device. Nonetheless, the overall device size of these embodiments may be orders of magnitude smaller than traditional approaches outlined above. This significant reduction (i.e., at least an order of magnitude) in size is also correlated to a similar reduction in weight. These two advantages (i.e., reducing size and weight) make the embedded planar waveguide approach especially suitable for use in wearable display systems.

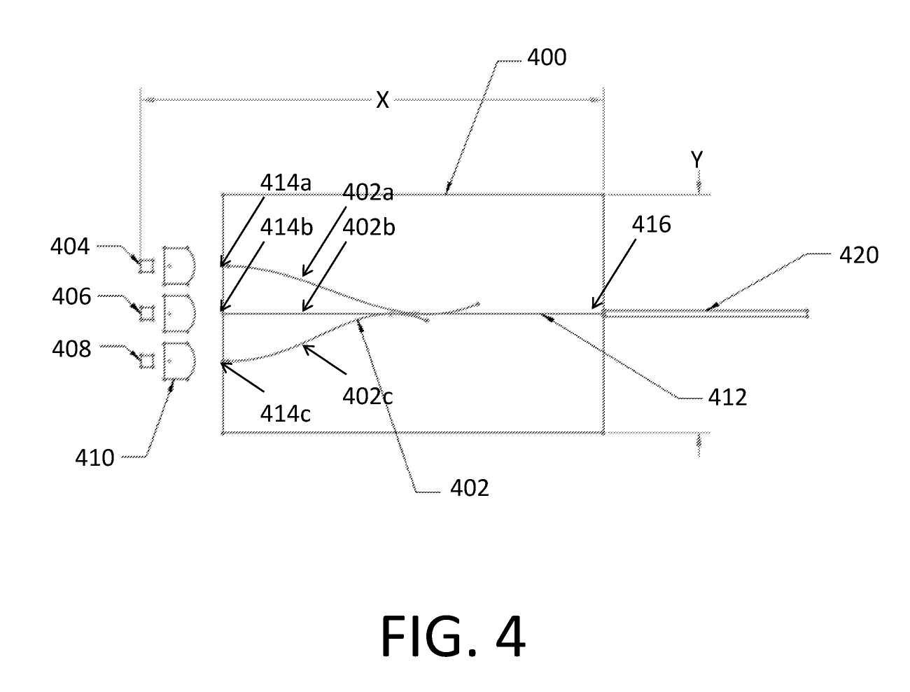

Referring now to FIG. 4, an example configuration of an embedded planar waveguide 402 to be used in combining lasers of various wavelengths is presented. As shown in FIG. 4, separate laser light beams are emitted from a red laser 404, a green laser 406 and a blue laser 408. Each of the emitted laser light beams passes through one or more lenses 410 (or other optical elements—not shown) before entering a waveguide 402 embedded in a planar waveguide substrate 400. The planar waveguide substrate 400 measures 10 mm (“X” in FIG. 4) by 5 mm (“Y” in FIG. 4), although these measurements are illustrative and not limiting. The embedded waveguide 402 includes three embedded waveguide channels 402a, 402b, 402c aligned with the red, green, and blue lasers 404, 406, 408, respectively. The first and third embedded waveguide channels 402a, 402c end shortly after converging on the second embedded waveguide channel (at different points) approximately halfway along the length of the waveguide substrate 400. The second embedded waveguide channel 402b traverses the length of the waveguide substrate 400. The left side of the waveguide substrate 400 in FIG. 4 represents the input side, where the three laser light beams enter the respective embedded waveguide channels 402a, 402b, 402c. The right side represents the output side where a combined visible laser light beam exits into a single-mode optical fiber 420. On the input side of the waveguide substrate 402, each of the three embedded waveguide channels 402a, 402b, 402c forms a respective input 414a, 414b, 414c. On the output side of the waveguide substrate 402, the middle embedded waveguide channel 402b forms a single mode output channel 416.

It should be appreciated that the waveguide substrate 400, including the embedded waveguide 402, may be made using semiconductor fabrication techniques (e.g., photo lithography and chemical processing) such that the waveguide substrate 400 is monolithic. The embedded waveguide 402 may have one or more refractive indices that are slightly higher (e.g., about 0.5% or higher) than the refractive index of the surrounding (non-waveguide) media of the waveguide substrate 400 that does not form the embedded waveguide, thereby guiding the light along respective predetermined paths as shown in FIG. 4. As shown in FIG. 4, the laser light beams from the three different discrete lenses 410 pass through the planar waveguide substrate 400 guided by respective embedded waveguide channels 402a, 402b, 402c.

As shown in FIG. 4, the red laser light beam and the blue laser light beam are directed toward the green laser light beam and eventually are coupled therewith by their respective embedded waveguide channels 402a, 402c, 402b. Coupling of the red and blue wavelength beams into the green wavelength beam in its embedded waveguide channel 402b may be accomplished through known optical techniques (e.g., evanescent coupling). For example, the respective embedded waveguide channels 402a, 402b, 402c for the red, green, and blue wavelength laser light beams may converge (as shown in FIG. 4) to couple the beams via frustrated total internal reflection.

In order to deliver light into the embedded waveguide channels 402a, 402b, 402c, each of the lasers 404, 406 408 is typically aligned with a respective lens 410 (e.g., via physical means, mechanical means, etc.) at the input side (left side in FIG. 4) of each respective embedded waveguide 402. As illustrated, the light beams from the discrete lasers 402, 406, 408 are combined to generate in a combined visible wavelength laser light beam 412 that is delivered into the optical fiber 420.

The lenses 410 may improve coupling efficiency due to both mode field diameter and numerical aperture mismatches between the lasers 402, 406, 408 and the single-mode embedded waveguide channels 402a, 402b, 402c. If a laser is butt coupled to (i.e., put in physical contact with) the waveguide substrate, light will still enter the embedded waveguide, but there will be significantly more loss. Thus, in a preferred embodiment, a lens 410 is aligned to each of the red, green and blue inputs 414a, 414b, 414c to the waveguide substrate 400 between the lasers 402, 406, 408 and the embedded waveguide channels 402a, 402b, 402c.

As shown in FIG. 4, the combined/multiplexed wavelength laser light beam 412 exits the waveguide substrate 400 and into a single-mode optical fiber output 420. This fiber 420 is aligned to a single-mode output channel 416 on output (right) side the waveguide substrate 400. Both the embedded waveguide 402 and the single-mode output fiber 420 may be designed such that they both have substantially the same mode field diameter and numerical aperture (e.g., a few percent, depending on system requirements), thereby minimizing light loss at the interface between the embedded waveguide 402 and the single-mode output fiber 420. As shown in FIG. 4, the optical fiber 420 may be butt coupled to the waveguide substrate 402 at the output channel 416. However, in one or more embodiments, a lens (not shown) may be placed between the waveguide substrate and the optical fiber to increase coupling efficiency. A typical lens for this application may be about 1 mm thick. However, the added lens may have the effect of slightly increasing the overall size (e.g., by about 10%) of the device.

It should be appreciated that although both single-mode and multi-mode wavelength combiners have been used to combine light in the infrared wavelength (1200-1600 nm) range, combining lasers in the visible wavelength (400-700 nm) range is more difficult because the visible wavelength combiners typically require small core waveguides, and are generally more difficult to align and fabricate when compared to similar components for infrared wavelengths.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A planar light combiner, comprising a planar substrate having a planar waveguide therein, the planar waveguide comprising a first channel and a second channel,
wherein the first channel is configured to propagate at least a first light having a first wavelength,
wherein the second channel is configured to propagate at least a second light having a second wavelength, and
wherein the first channel intersects the second channel such that the first light is combined with the second light.

2. The planar light combiner of claim 1, wherein each of the first and second wavelengths is in a range of about 400 nm to about 700 nm.

3. The planar light combiner of claim 1, wherein the second channel is configured to propagate the first light having the first wavelength.

4. The planar light combiner of claim 1, the planar substrate comprising an input side and an output side.

5. The planar light combiner of claim 4, wherein the second channel spans the planar substrate between the input side and the output side.

6. The planar light combiner of claim 4, the first channel comprising a first input at the input side.

7. The planar light combiner of claim 4, the second channel comprising a second input at the input side.

8. The planar light combiner of claim 4, the second channel comprising an output channel at the output side.

9. The planar light combiner of claim 8, wherein the output channel is a single mode channel.

10. The planar light combiner of claim 4, wherein the first channel does not extend to the output side.

11. The planar light combiner of claim 1, wherein the planar light combiner is monolithic.

12. The planar light combiner of claim 1, wherein the planar waveguide in the planar substrate has at least one waveguide refractive index that is higher than a non-waveguide refractive index in a non-waveguide portion of the planar substrate.

13. The planar light combiner of claim 1, wherein the first light is combined with the second light by evanescent coupling.

14. The planar light combiner of claim 1, wherein the first light is combined with the second light to form a multiplexed wavelength light.

15. The planar light combiner of claim 1, wherein the first and second channels are single mode channels.

16. The planar light combiner of claim 1, the planar waveguide further comprising a third channel,
wherein the third channel is configured to propagate at least a third light having a third wavelength, and
wherein the third channel intersects the second channel such that the third light is combined with the second light.

17. A light generator, comprising:
the planar light combiner of claim 1;
a first light source configured to deliver the first light to the first channel of the planar waveguide; and
a second light source configured to deliver the second light to the second channel of the planar waveguide.

18. The light generator of claim 17, wherein the first and second light sources are lasers.

19. The light generator of claim 17, further comprising:
a first lens disposed between the first light source and the first channel; and
a second lens disposed between the second light source and the second channel.

20. The light generator of claim 19, wherein the first light source, the first lens, and the first channel are aligned such that the first light from the first light source is delivered to the first channel.

21. The light generator of claim 19, wherein the second light source, the second lens, and the second channel are aligned such that the second light from the second light source is delivered to the second channel.

22. The light generator of claim 19, wherein the first lens is configured to improve a coupling efficiency between the first light source and the first channel by modifying one or more characteristics of the first light.

23. The light generator of claim 22, wherein the one or more characteristics is one or more of mode field diameter and numerical aperture.

24. The light generator of claim 19, wherein the second lens is configured to improve a coupling efficiency between the second light source and the second channel by modifying one or more characteristics of the second light.

25. The light generator of claim 24, wherein the one or more characteristics is one or more of mode field diameter and numerical aperture.

26. The light generator of claim 17, further comprising an optical fiber configured to receive a multiplexed wavelength light from the second channel of the planar waveguide.

27. The light generator of claim 26, wherein the optical fiber is a single mode fiber.

28. The light generator of claim 26, wherein the optical fiber is directly coupled to the planar substrate adjacent the second channel.

29. The light generator of claim 26, further comprising a lens disposed between the second channel and the optical fiber.

30. The light generator of claim 29, wherein the lens is configured to improve a coupling efficiency between the optical fiber and the second channel by modifying one or more characteristics of the multiplexed wavelength light.

31. The light generator of claim 30, wherein the one or more characteristics is one or more of mode field diameter and numerical aperture.

32. The light generator of claim 26, wherein the second channel and the optical fiber have substantially the same mode field diameter and numerical aperture.

33. The light generator of claim 17, the planar waveguide further comprising a third channel, the light generator further comprising a third light source configured to deliver a third light having a third wavelength to the third channel of the planar waveguide
wherein the third channel is configured to propagate at least the third light, and
wherein the third channel intersects the second channel such that the third light is combined with the second light.

34. The light generator of claim 33, further comprising a third lens disposed between the third light source and the third channel, wherein the third light source, the third lens, and the third channel are aligned such that the third light from the third light source is delivered to the third channel.
